(19) United States
(12) Patent Application Publication
(10) Pub. No.: US 2026/0024434 A1
(43) Pub. Date: Jan. 22, 2026

(54) APPARATUS AND METHOD FOR GENERATING TRAFFIC INFORMATION

(71) Applicants: Hyundai Motor Company, Seoul (KR); Kia Corporation, Seoul (KR)

(72) Inventor: Won Seok Yang, Hwaseong (KR)

(21) Appl. No.: 18/937,845

(22) Filed: Nov. 5, 2024

(30) Foreign Application Priority Data
Jul. 17, 2024 (KR) 10-2024-0094484

(51) Int. Cl. G08G 1/01; G06V 20/58; G06V 20/62; G08G 1/052

(52) U.S. Cl. CPC G08G 1/0133; G06V 20/58; G06V 20/625; G08G 1/0112; G08G 1/0145; G08G 1/052; G06V 2201/08

(57) ABSTRACT

An apparatus and a method are configured to generate traffic information based on vehicles that may or may not include GPS or communication devices. The apparatus for generating traffic information includes a memory that stores instructions for traffic information generation, and a processor that executes the instructions. The processor may determine a traveling vehicle by excluding duplicate vehicles from surrounding vehicles based on location information of relay vehicles traveling on a road and vehicle information of the surrounding vehicles, the surrounding vehicles being detected by the relay vehicles, and generate the traffic information based on traveling information of the traveling vehicle.

### CROSS-REFERENCE TO RELATED APPLICATION

This application claims under 35 U.S.C. § 119 (a) the benefit of Korean Patent Application No. 10-2024-0094484, filed in the Korean Intellectual Property Office on Jul. 17, 2024, the entire contents of which are incorporated herein by reference.

### BACKGROUND

### (a) Technical Field

The present disclosure relates to an apparatus and a method for generating traffic information, more particularly, to a technique for generating traffic information based on vehicles that may or may not include GPS or communication devices.

### (b) Description of the Related Art

Traffic information may be used to determine the flow of traffic on a road and may be used for traffic guidance and navigation.

Traffic information may be generated based on the direct collection of GPS information and vehicle speeds of vehicles traveling on the road. To determine traffic information more accurately, data from a larger number of vehicles needs to be collected.

However, many vehicles are not yet equipped with GPS devices and communication devices, or have established communication protocols with external servers to generate traffic information.

To complement this, GPS information from a mobile device on board the vehicle may be used. However, the use of information from the mobile device may conflict with institutional regulations because the information from the mobile devices is personal information, and when a user with the mobile device temporarily leaves the vehicle, the traffic information data from the vehicle may become inaccurate.

Therefore, a more accurate way to determine traffic information is required.

### SUMMARY

An aspect of the present disclosure provides an apparatus and a method for generating traffic information capable of collecting traffic information of vehicles without using personal information.

An aspect of the present disclosure provides an apparatus and a method for generating traffic information capable of collecting traffic information of vehicles that are not equipped with GPS devices or communication devices.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for generating traffic information includes a memory that stores instructions for traffic information generation, a processor that executes the instructions. The processor may determine a traveling vehicle by excluding duplicate vehicles from surrounding vehicles based on location information of relay vehicles traveling on a road and vehicle information of the surrounding vehicles, the surrounding vehicles being detected by the relay vehicles, and generate the traffic information based on traveling information of the traveling vehicle.

According to an embodiment, the processor may identify license plate information from the vehicle information of the surrounding vehicles, and determine, as the traveling vehicle, one of the surrounding vehicles of which the license plate information are identical.

According to an embodiment, the processor may decrypt the license plate information provided as encrypted data.

According to an embodiment, the processor may identify relative locations of the surrounding vehicles with respect to the relay vehicle from the vehicle information of the surrounding vehicles, determine absolute locations of the surrounding vehicles based on the location information of the relay vehicle and the relative locations of the surrounding vehicles, and determine one of the surrounding vehicles as the traveling vehicle among the surrounding vehicles of which the absolute locations are identical.

According to an embodiment, the processor may determine the absolute locations of the surrounding vehicle based on line information of the surrounding vehicles.

According to an embodiment, the processor may determine duplicate vehicles among the surrounding vehicles based on color information or size information of the vehicle information of the surrounding vehicles.

According to an embodiment, the processor may determine a speed of the traveling vehicle based on speed information of the relay vehicle and an amount of change in the relative location of the traveling vehicle over time, and include the speed information of the traveling vehicle in the traffic information.

According to an embodiment, the processor may determine the relative location of the traveling vehicle at predetermined time periods, determine a relative speed of the traveling vehicle based on the amount of change in the relative location of the traveling vehicle at the predetermined time periods, and determine a speed of the traveling vehicle based on the speed information of the relay vehicle and the relative speed of the traveling vehicle.

According to an embodiment, the processor may determine a detection time at which the traveling vehicle is detected by a side-rear detection sensor of the relay vehicle, determine a relative speed of the traveling vehicle based on a detection distance of the side-rear sensor and the detection time, and determine a speed of the traveling vehicle based on the speed information of the relay vehicle and the relative speed of the traveling vehicle.

According to an embodiment, the processor may match the location information of the traveling vehicle and a speed of the traveling vehicle to a link connecting nodes corresponding to points where a speed change occurs.

According to an embodiment, a server may include the above-described apparatus, the server being operably connected to at least a vehicle.

According to an aspect of the present disclosure, a method for generating traffic information includes receiving, by a server, location information of relay vehicles on a road and vehicle information of surrounding vehicles detected by the relay vehicles, determining, by the server, a traveling vehicle by excluding duplicate vehicles from surrounding vehicles based on the location information of the relay vehicles and the vehicle information of the surrounding vehicles, and generating, by the server, the traffic information based on traveling information of the traveling vehicle.

According to an embodiment, the determining of the traveling vehicle may include identifying license plate information from the vehicle information of the surrounding vehicles, and determining, as the traveling vehicle, one of the surrounding vehicles of which the license plate information are identical.

According to an embodiment, the identifying of the license plate information from the vehicle information may include receiving the license plate information recognized by the relay vehicle, which is encrypted data, and decrypting the encrypted data.

According to an embodiment, the determining of the traveling vehicle may include identifying relative locations of the surrounding vehicles with respect to the relay vehicle from the vehicle information of the surrounding vehicles, determining absolute locations of the surrounding vehicles based on the location information of the relay vehicle and the relative locations of the surrounding vehicles, and determining one of the surrounding vehicles as the traveling vehicle among the surrounding vehicles of which the absolute locations are identical.

According to an embodiment, the identifying relative locations of the surrounding vehicles may include identifying line information of the surrounding vehicles.

According to an embodiment, the determining of the traveling vehicle may further include using color information or size information of the vehicle information of the surrounding vehicles.

According to an embodiment, the generating of the traffic information based on the traveling information of the traveling vehicle may further include determining a speed of the traveling vehicle based on speed information of the relay vehicle and an amount of change in the relative location of the traveling vehicle over time.

According to an embodiment, the determining of the speed of the traveling vehicle may include determining the relative location of the traveling vehicle at predetermined time periods, determining a relative speed of the traveling vehicle based on the amount of change in the relative location of the traveling vehicle at the predetermined time periods, and determining a speed of the traveling vehicle based on the speed information of the relay vehicle and the relative speed of the traveling vehicle.

According to an embodiment, the determining of the speeds of the traveling vehicle may include determining a detection time at which the traveling vehicle is detected by a side-rear detection sensor of the relay vehicle, determining a relative speed of the traveling vehicle based on a detection distance of the side-rear sensor and the detection time, and determining a speed of the traveling vehicle based on the speed information of the relay vehicle and the relative speed of the traveling vehicle.

According to an embodiment, the generating of the traffic information may include matching a location and speed of the traveling vehicle to a link connecting nodes corresponding to points where a speed change occurs.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram for describing a method for generating traffic information according to an embodiment of the present disclosure;

FIG. 2 is a block diagram showing the configuration of a system for generating traffic information according to an embodiment of the present disclosure;

FIG. 3 is a diagram for describing a sensor device of a relay vehicle;

FIG. 4 is a flowchart for describing a method for generating traffic information according to an embodiment of the present disclosure;

FIG. 5 is a drawing for describing a method of matching surrounding vehicles to a link;

FIG. 6 is a flowchart for describing a method for generating traffic information according to another embodiment of the present disclosure;

FIG. 7 is a diagram for describing an embodiment of determining duplicate vehicles;

FIG. 8 is a diagram for describing a method of determining duplicate vehicles according to another embodiment;

FIGS. 9 and 10 are diagrams for describing a method for determining speed information of a traveling vehicle according to an embodiment of the present disclosure;

FIG. 11 is a diagram illustrating a computing system according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary diagrams. In adding the reference numerals to the components of each diagram, it should be noted that the identical or equivalent component is designated by the identical numeral even when they are displayed on other diagrams. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

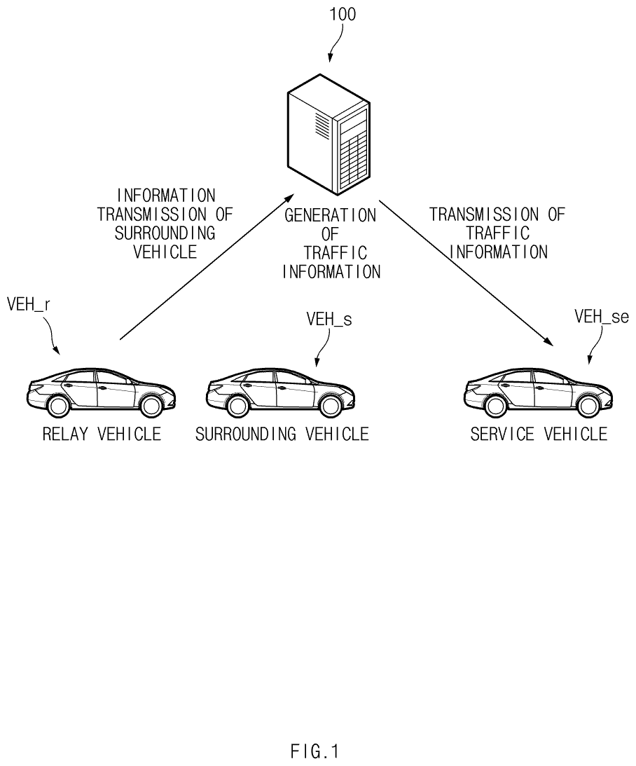

Hereinafter, embodiments of the present disclosure will be described in detail with reference to FIGS. 1 to 11.

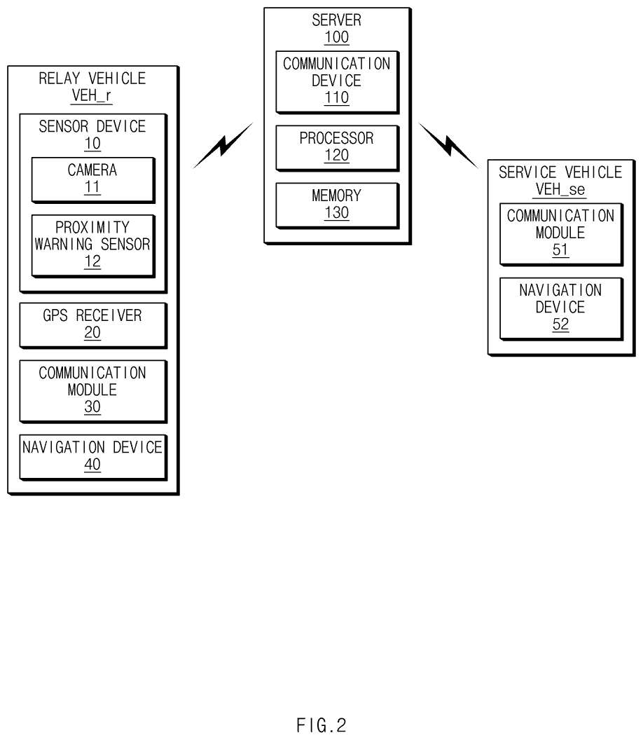

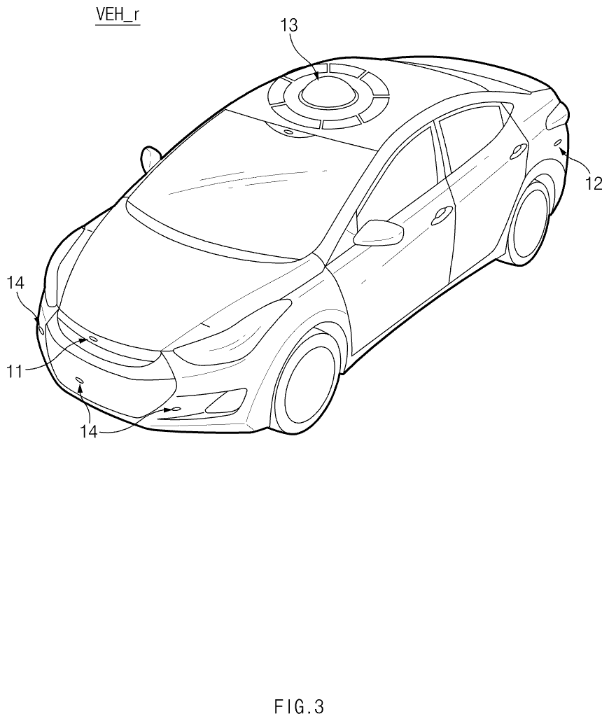

FIG. 1 is a diagram for describing a method for generating traffic information according to an embodiment of the present disclosure, and FIG. 2 is a block diagram showing the configuration of a system for generating traffic information according to an embodiment of the present disclosure. FIG. 3 is a diagram for describing a sensor device of a relay vehicle.

Referring to FIGS. 1 to 3, a system for generating traffic information according to an embodiment of the present disclosure and a method for generating traffic information using the same will be described below.

The system for generating traffic information according to an embodiment of the present disclosure may include a relay vehicle VEH_r and a server 100.

The relay vehicle VEH_r may detect surrounding vehicles VEH_s around the relay vehicle and provide information about the detected surrounding vehicles VEH_s to the server 100. To this end, the relay vehicle VEH_r may include a sensor device 10, a GPS receiver 20, a communication module 30, and a navigation device 40.

The sensor device 10 may include a camera 11 that detects external objects outside the relay vehicle VEH_r, and a proximity warning sensor 12.

The camera 11 may be positioned at the front of the vehicle as in FIG. 3 to obtain an external image of the vehicle, or may be positioned at the rear, right side mirror, left side mirror, or the like of the vehicle. The camera may be a mono camera, a stereo camera, an Around View Monitoring (AVM) camera, or a 360-degree camera.

The relay vehicle VEH_r may perform artificial intelligence learning to detect surrounding vehicles VEH_s from an image obtained by the camera 11. To this end, the relay vehicle VEH_r may include an artificial intelligence (AI) processor. The AI processor may learn a neural network using a pre-stored program. A neural network for detecting a target vehicle and a dangerous vehicle may be designed to simulate a human brain structure on a computer, and may include a plurality of network nodes having weights that simulate neurons of a human neural network. The plurality of network nodes may exchange data according to a connection relationship to cause the neurons to simulate synaptic activity of neurons that exchange signals via synapses. The neural network may include a deep learning model developed from a neural network model. In a deep learning model, the plurality of network nodes may be located in different layers to exchange data according to a convolution connection relationship. Examples of neural network models may include various deep learning techniques such as deep neural networks (DNNs), convolutional deep neural networks (CNNs), recurrent neural networks (RNNs), Restricted Boltzmann Machines (RBMs), deep belief networks (DBNs), and deep Q-networks.

The proximity warning sensor 12 may detect an object approaching the relay vehicle VEH_r using a camera or a radar, and generate an alarm when the object is within a certain distance from the vehicle. The proximity warning sensor 12 may be a Blind Spot Detection (BSD) device for detecting the rear side of the relay vehicle VEH_r.

In addition, the sensor device 10 may further include a Light Imaging Detection and Ranging (LIDAR) 13 and a Radio Detection and Ranging (RADAR) 14.

The LIDAR 13 may include a laser transmission module and a laser reception module. The LIDAR may be implemented in a TOF (Time of Flight) method or a phase-shift method. The LIDAR may be exposed to the outside of the vehicle to detect an object located in front, rear, or side of the vehicle.

The RADAR 14 may include an electromagnetic wave transmission module and an electromagnetic wave reception module, and may detect the location of an object as well as the distance and relative speed from the detected object. The RADAR may be implemented in a pulse radar method or a continuous wave radar method based on the principle of radio wave. Among the continuous wave radar methods, the RADAR may be implemented in an FMCW (Frequency Modulated Continuous Wave) method or an FSK (Frequency Shift keying) method according to signal waveforms.

In addition, the sensor device 10 may include an ultrasonic sensor, an infrared sensor, or the like. The ultrasonic sensor may detect an object based on ultrasonic waves, and may detect the location of the detected object, and the distance from the detected object and the relative speed with respect to the detected object. The ultrasonic sensor may be placed at an appropriate location outside the vehicle to detect an object located in the front, rear, or side of the vehicle. The infrared sensor may detect an object using infrared light, and may detect the location of the detected object, the distance from the detected object, and the relative speed with respect to the detected object.

The GPS receiver 20 is for obtaining location information based on the Global Positioning System, and may obtain location information of the relay vehicle VEH_r by receiving signals from satellites.

The communication module 30 may transmit and receive radio signals to and from the server 100 on a mobile communication network established in accordance with technical standards or communication methods for mobile communication. The communication module 30 may perform communication based on Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), or LTE-A (Long Term Evolution-Advanced).

The navigation device 40 may provide route guidance based on the location of the relay vehicle VEH_r determined by map data and the GPS receiver 20.

The server 100 may include a traffic information generating device, and the traffic information generating device may include a communication device 110, a processor 120, and a memory 130.

The communication device 110 may perform communication with the relay vehicle VEH_r to receive location information of the relay vehicle VEH_r and vehicle information of the surrounding vehicles VEH_s.

The processor 120 may select a traveling vehicle by excluding duplicate vehicles from among the surrounding vehicles VEH_s by executing instructions (e.g., regarding an algorithm) stored in the memory 130. The processor 120 may generate traffic information based on the traveling vehicle and transmit the generated traffic information to service vehicles VEH_se. The traffic information may be for determining a traffic volume on a road.

The memory 130 may store instructions for the operation of the processor 120. The memory 130 may be implemented using a hard disk drive, flash memory, electrically erasable programmable read-only memory (EEPROM), static RAM (SRAM), ferro-electric RAM (FRAM), phase-change RAM (PRAM), magnetic RAM (MRAM), Dynamic Random Access (DRAM), Synchronous Dynamic Random Access Memory (SDRAM), Double Data Rate-SDRAM (DDR-SDRAM), and the like.

The service vehicle VEH_se may perform route guidance using traffic information provided through a communication module 51 and map data stored in a navigation device 52.

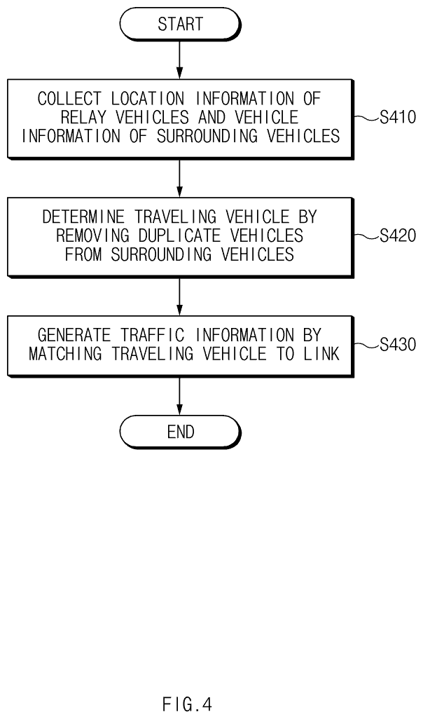

Hereinafter, the method for generating traffic information in a server according to an embodiment of the present disclosure will be described with reference to FIG. 4.

FIG. 4 is a flowchart for describing a method for generating traffic information according to an embodiment of the present disclosure. Processes performed by the server illustrated in FIG. 2 will be mainly described with reference to FIG. 4.

In S410, the server 100 may receive location information of the relay vehicles VEH_r and vehicle information of the surrounding vehicles VEH_s from one or more relay vehicles VEH_r using the communication device 110.

The location information of the relay vehicles VEH_r may be latitude and longitude information acquired by the GPS receiver 20. The vehicle information of the surrounding vehicles VEH_s may include relative location information of the surrounding vehicles VEH_s with respect to the relay vehicles VEH_r, vehicle color information, vehicle size information, or the like.

In S420, the processor 120 of the server 100 may determine a traveling vehicle by excluding duplicate vehicles among the surrounding vehicles VEH_s based on the location information of the relay vehicles VEH_r and the vehicle information of the surrounding vehicles.

To determine duplicate vehicles, the processor 120 may determine the absolute locations of the surrounding vehicles VEH_s. The processor 120 may determine the absolute location of the surrounding vehicle VEH_s based on the location information of the relay vehicle VEH_r and the relative location of the surrounding vehicle VEH_s with respect to the relay vehicle VEH_r. The relative location of the surrounding vehicle VEH_s may include a distance between the relay vehicle VEH_r and the surrounding vehicle VEH_s, an angle between a straight line connecting the relay vehicle VEH_r and the surrounding vehicle VEH_s and the heading direction of the relay vehicle VEH_r, and the line information of the surrounding vehicle VEH_s.

When the surrounding vehicles VEH_s are duplicates, the processor 120 may determine only one vehicle among the duplicate surrounding vehicles VEH_s to be a traveling vehicle. The duplicate surrounding vehicles VEH_s may be the same surrounding vehicle VEH_s detected by different relay vehicles VEH_r.

The processor 120 may use color information and size information of the surrounding vehicles VEH_s to determine the duplicate vehicles.

In addition, the processor 120 may determine the duplicate vehicles based on the license plate information of the surrounding vehicles VEH_s. The license plate information may be included in the vehicle information of the surrounding vehicles VEH_s provided from the relay vehicle VEH_r. The relay vehicle VEH_r may detect a license plate from an image acquired through the camera 11 and identify a vehicle number. The relay vehicle VEH_r may encrypt the vehicle number and provide the encrypted vehicle number to the server 100. The server 100 may decrypt the encrypted vehicle number.

In S430, the processor 120 of the server 100 may generate traffic information based on the traveling information of traveling vehicles.

The server 100 may generate traffic information by matching the locations and speeds of the traveling vehicles to a link. The link may be generated by connecting nodes corresponding to points where a speed change occurs, and may include a plurality of lanes.

Detailed examples of the processes for generating traffic information will be described below.

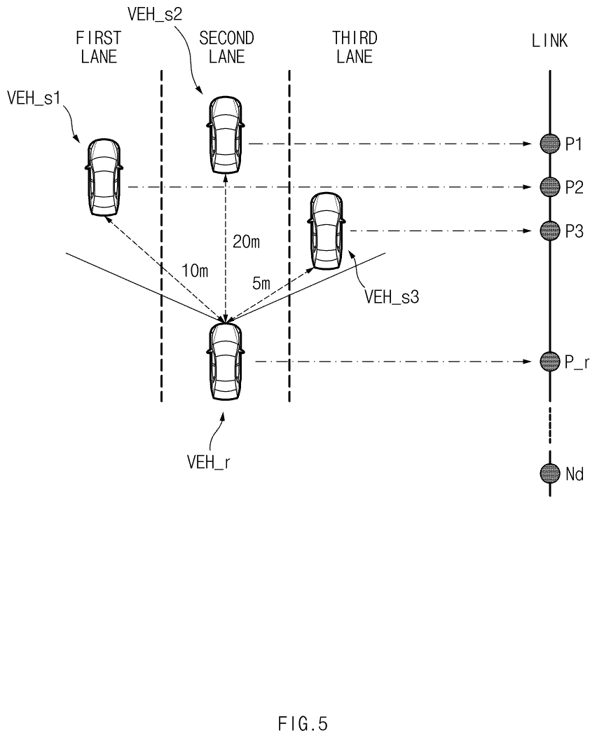

FIG. 5 is a diagram for describing a method of matching surrounding vehicles to a link.

Referring to FIG. 5, the relay vehicle VEH_r traveling on a road may detect surrounding vehicles VEH_s1, VEH_s2, and VEH_s3 around the relay vehicle VEH_r using the camera 11.

The relay vehicle VEH_r may provide the server 100 with vehicle information about the first surrounding vehicle VEH_s1, the second surrounding vehicle VEH_s2, and the third surrounding vehicle VEH_s3 along with the location information of the relay vehicle VEH_r.

The vehicle information may include relative location information. The relative location information may include a distance from the relay vehicle VEH_r, line information, and an angle at which a surrounding vehicle is located with respect to the heading direction of the relay vehicle VEH_r.

For example, the relative location information of the first surrounding vehicle VEH_s1 may include relative distance=10 m, angle information=deg1, and lane information=1 (first lane). The relative location information of the second surrounding vehicle VEH_s2 may include relative distance=20 m, angle information=deg2, and lane information=2 (second lane), and the relative location information of the third surrounding vehicle VEH_s3 may include relative distance=5 m, angle information=deg3, and lane information-3 (third lane).

The server 100 may match the location of the relay vehicle VEH_r to point “r” P_r of a link based on the location information of the relay vehicle VEH_r. In addition, the server 100 may match the second surrounding vehicle VEH_s2 to a first point P1 of the link based on the location information of the relay vehicle VEH_r and the relative location information of the first surrounding vehicle VEH_s1. Similarly, the server 100 may match the first surrounding vehicle VEH_s1 to a second point P2 of the link based on the location information of the relay vehicle VEH_r and the relative location information of the second surrounding vehicle VEH_s2, and may match the third surrounding vehicle VEH_s3 to a third point P3 of the link based on the location information of the relay vehicle VEH_r and the relative location information of the third surrounding vehicle VEH_s3.

The location information of the point “r” P_r and the first to third points P1, P2, and P3 may include distance information from a node Nd. The node Nd may refer to a point at which a change in the traveling speed of a vehicle on a road is likely to occur, for example, an intersection, an intersection start/end point, an overpass start/end point, a road start/end point, or the like.

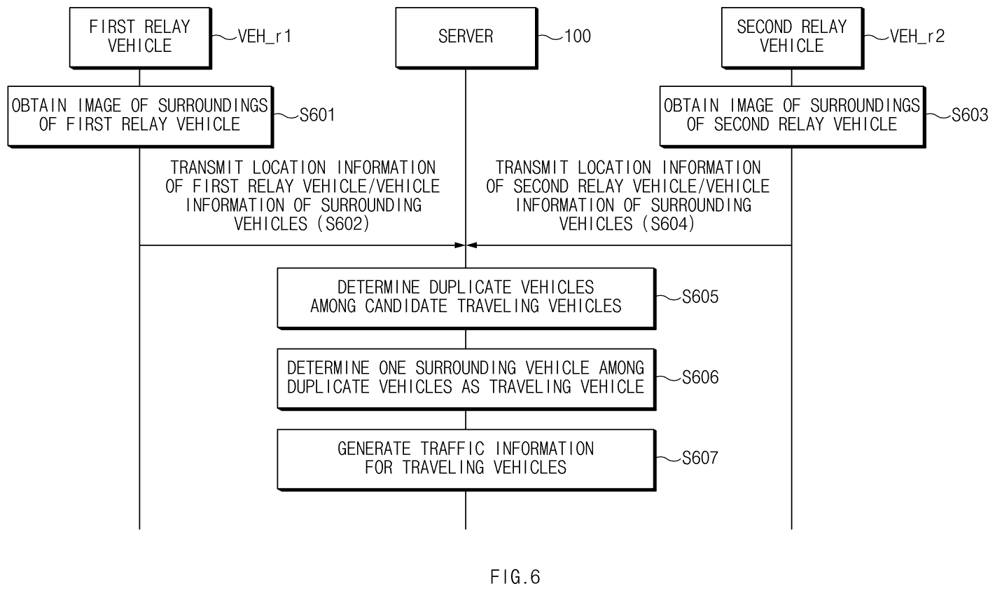

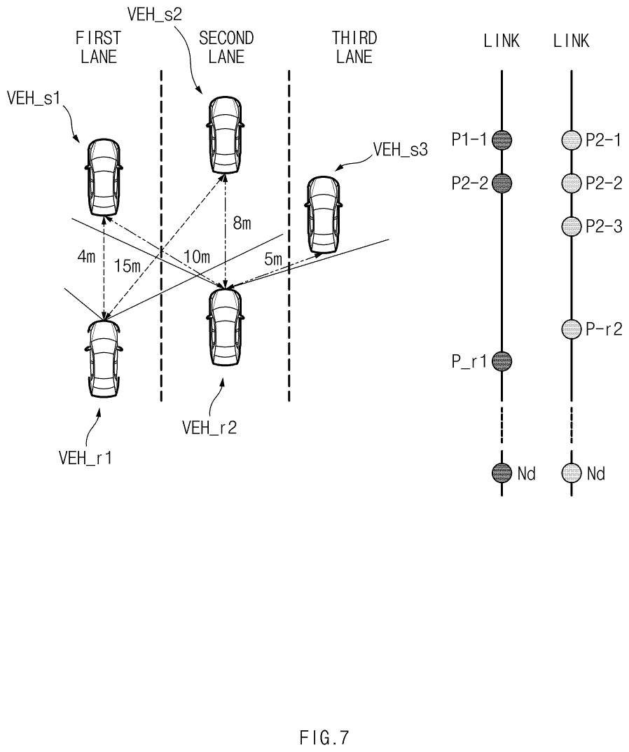

FIG. 6 is a flowchart for describing a method for generating traffic information according to another embodiment of the present disclosure. FIG. 7 is a diagram for describing an embodiment of determining duplicate vehicles.

Referring to FIG. 6 and FIG. 7, a method for generating traffic information according to another embodiment of the present disclosure will be described below.

In S601, a first relay vehicle VEH_r1 may obtain an image of surroundings via the camera 11.

The first relay vehicle VEH_r1 may detect the first surrounding vehicle VEH_s1 and the second surrounding vehicle VEH_s2 from the image, and determine vehicle information of the first surrounding vehicle VEH_s1 and the second surrounding vehicle VEH_s2 based on the image. The vehicle information of the first surrounding vehicle VEH_s1 may include the relative location of the first surrounding vehicle VEH_s1 with respect to the first relay vehicle VEH_r1, and the color information, size information, and license plate information of the first surrounding vehicle VEH_s1. The vehicle information of the second surrounding vehicle VEH_s2 may include the relative location of the second surrounding vehicle VEH_s2 with respect to the first surrounding vehicle VEH_s1, and the color information, size information, and license plate information of the second surrounding vehicle VEH_s2.

In S602, the first relay vehicle VEH_r1 may provide the server 100 with the vehicle information of the first surrounding vehicle VEH_s1 and the vehicle information of the second surrounding vehicle VEH_s2 together with the location information of the first relay vehicle VEH_r1.

In S603, a second relay vehicle VEH_r2 may obtain an image of surroundings via the camera 11.

The second relay vehicle VEH_r2 may detect the first surrounding vehicle VEH_s1, the second surrounding vehicle VEH_s2, and the third surrounding vehicle VEH_s3 from the image, and determine vehicle information of the first surrounding vehicle VEH_s1, the second surrounding vehicle VEH_s2, and the third surrounding vehicle VEH_s3 based on the image. The vehicle information of the third surrounding vehicle VEH_s3 may include the relative location of the third surrounding vehicle VEH_s3 with respect to the second relay vehicle VEH_r2, and the color information, size information, and license plate information of the third surrounding vehicle VEH_s3.

In S604, the second relay vehicle VEH_r2 may provide the server 100 with the vehicle information of the first surrounding vehicle VEH_s1, the vehicle information of the second surrounding vehicle VEH_s2, and the vehicle information of the third surrounding vehicle VEH_s3 together with the location information of the second relay vehicle VEH_r2.

In S605, the server 100 may determine duplicate vehicles among the surrounding vehicles, and determine one surrounding vehicle among the duplicate vehicles as a traveling vehicle.

According to an embodiment, the server 100 may match the surrounding vehicles VEH_s1, VEH_s2, and VEH_s3 to a link, and determine duplicate vehicles based on the locations of the surrounding vehicles VEH_s1, VEH_s2, and VEH_s3 matched to the link.

For example, the server 100 may match the location of the first relay vehicle VEH_r1 to point r1 P_r1 of the link based on the location information of the first relay vehicle VEH_r1. In addition, the server 100 may match the first surrounding vehicle VEH_s1 to a (1-1)-th point P1-1 of the link based on the location information of the first relay vehicle VEH_r1 and the relative location information of the first surrounding vehicle VEH_s1. Similarly, the server 100 may match the second surrounding vehicle VEH_s2 to a (1-2)-th point P1-2 of the link based on the location information of the first relay vehicle VEH_r1 and the relative location information of the second surrounding vehicle VEH_s2.

The server 100 may match the location of the second relay vehicle VEH_r2 to a point r2 P_r2 of the link based on the location information of the second relay vehicle VEH_r2. In addition, the server 100 may match the first surrounding vehicle VEH_s1 to a (2-1)-th first point P2-1 of the link based on the location information of the second relay vehicle VEH_r2 and the relative location information of the first surrounding vehicle VEH_s1. Similarly, the server 100 may match the second surrounding vehicle VEH_s2 to a (2-2)-th point P2-2 of the link based on the location information of the second relay vehicle VEH_r2 and the relative location information of the second surrounding vehicle VEH_s2, and may match the third surrounding vehicle VEH_s3 to a (2-3)-th point P2-3 of the link based on the location information of the second relay vehicle VEH_r2 and the relative location information of the third surrounding vehicle VEH_s3.

The location information of the point P1-1 and the (1-2)-th point P1-2 may include distance information from the node Nd.

The (2-1)-th point P2-1, the (2-2)-th point P2-2, and the (2-3)-th point P2-3 may include distance information from the node Nd.

The server 100 may determine whether the location information of surrounding vehicles generated using the vehicle information provided from the first relay vehicle VEH_r1 and the location information of surrounding vehicles generated using the vehicle information provided from the second relay vehicle VEH_r2 are identical to each other. For example, when the (1-1)-th point P1-1 and the (2-1)-th point P2-1 include the same distance information, the server 100 may determine that the first surrounding vehicle VEH_s1 is detected repeatedly by the first relay vehicle VEH_r1 and the second relay vehicle VEH_r2.

According to another embodiment, S605 may be performed based on the locations of surrounding vehicles specified in a lane.

To this end, the server 100 may determine the absolute locations of vehicles based on the location information of the first relay vehicle VEH_r1 and the vehicle information of surrounding vehicles VEH_s1, VEH_s2, and VEH_s3 provided from the first relay vehicle VEH_r1. [Table 1] below is a table showing examples of the location information of the first relay vehicle VEH_r1 and the vehicle information of surrounding vehicles VEH_s1, VEH_s2, and VEH_s3 provided from the first relay vehicle VEH_r1.

TABLE 1

| Link ID: ID#1 | VEH_r1 | VEH_s1 | VEH_s2 |
|---|---|---|---|
| GPS information | (latitude, longitude) | — | — |
| Vehicle number | 0000 | 265675 | 266475 |
| Vehicle color | — | White | Black |
| Line information | — | 0 | −1 |
| Relative speed | 0 | 4(m) | 15(m) |
| Heading angle | 0 | +5(°) | +45(°) |

In addition, the server 100 may determine the absolute locations of vehicles based on the location information of the second relay vehicle VEH_r2 and the vehicle information of surrounding vehicles VEH_s1, VEH_s2, and VEH_s3 provided from the second relay vehicle VEH_r2. [Table 2] below is a table showing examples of the location information of the second relay vehicle VEH_r2 and the vehicle information of surrounding vehicles VEH_s1, VEH_s2, and VEH_s3 provided from the second relay vehicle VEH_r2.

TABLE 2

| Link ID: ID#1 | VEH_r2 | VEH_s1 | VEH_s2 | VEH_s2 |
|---|---|---|---|---|
| GPS information | (latitude, | — | — | — |
| | longitude) | | | |
| Vehicle number | 0000 | 265675 | 266475 | 156475 |
| Vehicle color | — | White | Black | Gray |
| Line information | — | +1 | 0 | −1 |
| Relative speed | 0 | 10(m) | 8(m) | 5(m) |
| Heading angle | 0 | −45(°) | −5(°) | +60(°) |

In [Table 1] and [Table 2], a link ID may be a unique link of the road on which the relay vehicles VEH_r1 and VEH_r2 are traveling. A vehicle number may be an encrypted unique number and transmitted to the server 100. The line information may be expressed together with information (−, +) indicating the heading with respect to the lines of the relay vehicles VEH_r1 and VEH_r2. The heading angle may be expressed in degrees together with information (−, +) indicating the heading of the detected vehicle with respect to the direction of travel of the relay vehicles VEH_r1 and VEH_r2.

The server 100 may determine the location of the first surrounding vehicle VEH_s1 on a road including a plurality of lanes based on the distance between the first relay vehicle VEH_r1 and the first surrounding vehicle VEH_s1, the heading angle of the first surrounding vehicle VEH_s1, and the line information of the first surrounding vehicle VEH_s1. Further, the server 100 may specifically determine the second relay vehicle VEH_r2 and the location of the second relay vehicle VEH_r2 on the road.

Similarly, the server 100 may specifically determine the locations of the first surrounding vehicle VEH_s1, the second surrounding vehicle VEH_s2, and the third surrounding vehicle VEH_s3 on the road.

The server 100 may determine duplicate vehicles by determining whether the locations of surrounding vehicles determined based on the vehicle information provided by the first relay vehicle VEH_r1 are identical to the locations of surrounding vehicles determined based on the vehicle information provided by the second relay vehicle VEH_r2.

In the process of determining the duplicate vehicles, the server 100 may additionally use the color information and size information of the surrounding vehicles.

In S606, the server 100 may determine one of the duplicate vehicles as a traveling vehicle.

For example, when the surrounding vehicle matched to the (1-1)-th point P1-1 and the surrounding vehicle matched to the (2-1)-th point P2-1 are the same vehicle, the server 100 may determine the first surrounding vehicle matched to the (1-1)-th point P1-1 is the traveling vehicle. Further, the server 100 may disregard the vehicle information of the first surrounding vehicle VEH_s1 provided by the second relay vehicle VEH_r2.

In S607, the server 100 may generate traffic information related to traveling vehicles.

The traffic information may include location information of traveling vehicles matched to the link and speed information of the traveling vehicles. The location information of the traveling vehicles may include distance information from the node.

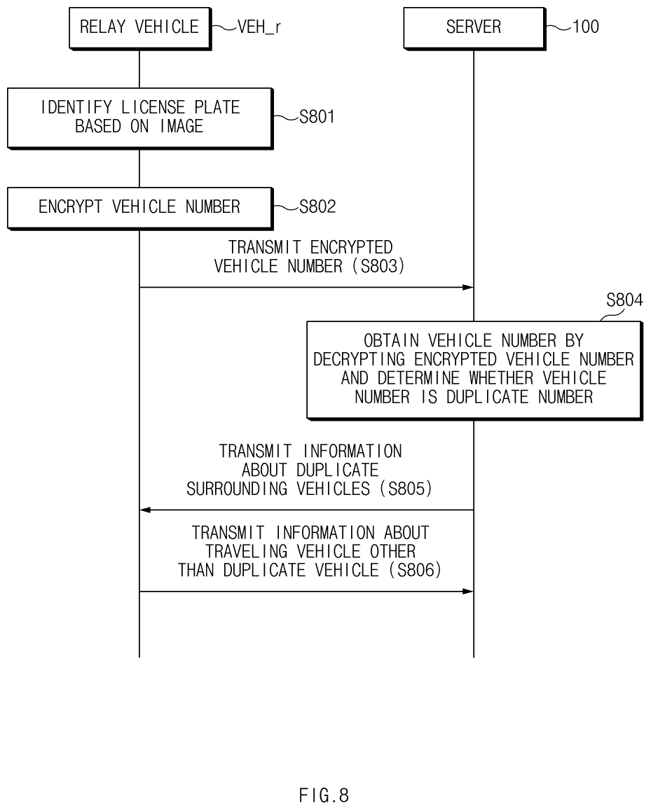

FIG. 8 is a diagram for describing a method of determining duplicate vehicles according to another embodiment. Referring to FIG. 8, a method of determining duplicate vehicles according to another embodiment of the present disclosure will be described in detail below.

In S801, the relay vehicle VEH_r may identify the license plate of a vehicle based on an image.

In S802, the relay vehicle VEH_r may recognize a vehicle number from the license plate of the vehicle and encrypt the vehicle number.

In S803, the relay vehicle VEH_r may transmit the encrypted vehicle number to the server 100.

In S804, the server 100 may decrypt the encrypted vehicle number to obtain the vehicle number. The server 100 may then determine whether the vehicle number is the duplicate of a vehicle number provided by another relay vehicle.

In S805, the server 100 may transmit, to the relay vehicle VEH_r, a message indicating that the vehicle number is duplicate when the vehicle number provided by the relay vehicle VEH_r is the same as the vehicle number provided by the other relay vehicle.

In S806, the relay vehicle VEH_r may provide the vehicle information of the surrounding vehicles excluding the duplicate vehicle to the server 100, without transmitting the vehicle information of the duplicate surrounding vehicle to the server 100.

In FIG. 8, S805 may be performed even when the duplicate vehicle is determined based on another embodiment. For example, the server 100 may provide information about the duplicate vehicle to the relay vehicles even when the server 100 has determined the duplicate vehicle based on the location information of the surrounding vehicles.

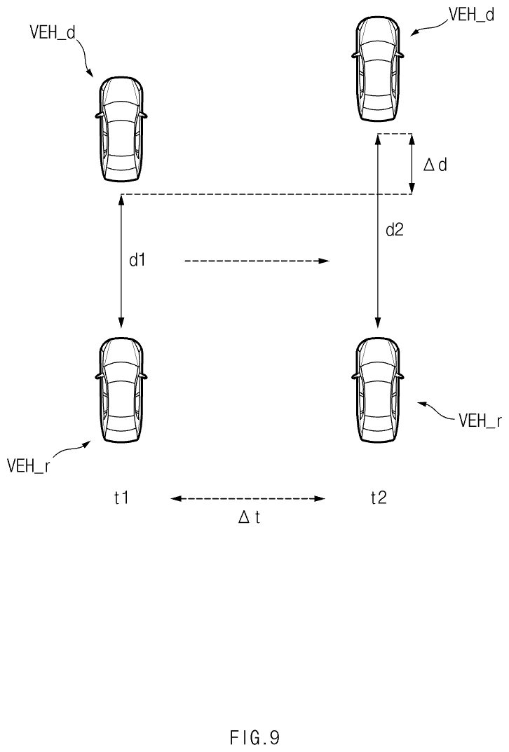

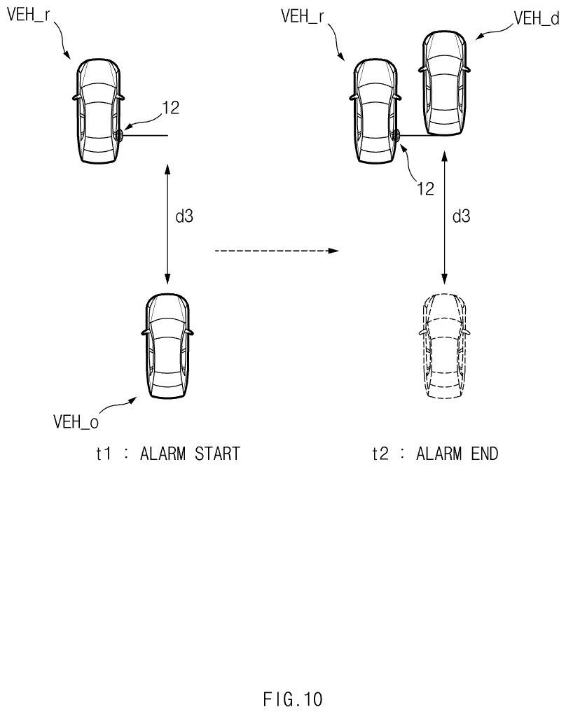

FIGS. 9 and 10 are diagrams for describing a method for determining speed information of a traveling vehicle according to an embodiment of the present disclosure. FIGS. 9 and 10 are diagrams for determining speed information of surrounding vehicles determined to be traveling vehicles which are obtained by removing duplicate vehicles from surrounding vehicles.

FIG. 9 is a diagram for describing a method for determining a speed of a traveling vehicle based on an image.

Referring to FIG. 9, the relay vehicle VEH_r may determine a distance d1 from a traveling vehicle VEH_d based on an image acquired at first timing t1.

Then, the relay vehicle VEH_r may determine a distance d2 from the traveling vehicle VEH_d based on an image acquired at second timing t2.

The relay vehicle VEH_r may determine Δt corresponding to a time interval between the first timing t1 and the second timing t2, and determine Δd corresponding to a distance difference between d2 and d1. Then, the relay vehicle VEH_r may determine a relative speed of the traveling vehicle VEH_d based on Δt and Δd.

The relay vehicle VEH_r may determine the speed of the traveling vehicle VEH_d based on the speed of the relay vehicle VEH_r and the relative speed of the traveling vehicle VEH_d.

FIG. 10 is a diagram for describing a method for determining a speed of a traveling vehicle using a proximity warning sensor.

Referring to FIG. 10, the relay vehicle VEH_r may identify timing t1 at which an alarm has started when the traveling vehicle VEH_d is detected by the proximity warning sensor 12.

The relay vehicle VEH_r may identify timing t2 at which the alarm has ended when the traveling vehicle VEH_d has deviated from a detection distance d3 of the proximity warning sensor 12.

The detection distance d3 of the proximity warning sensor 12 may be a pre-designed value.

The relay vehicle VEH_r may determine the relative speed of the traveling vehicle VEH_d based on the time interval between the first timing t1 in which the alarm is sent and the second timing t2 and the detection distance d3.

The relay vehicle VEH_r may determine the speed of the traveling vehicle VEH_d based on the speed of the relay vehicle VEH_r and the relative speed of the traveling vehicle VEH_d.

The embodiments illustrated in FIGS. 9 and 10 may be performed by the server. The relay vehicle VEH_r may provide the speed information of the relay vehicle VEH_r and the detection distance information of the proximity warning sensor to the server 100, and provide the image information of the traveling vehicle VEH_d, the detection time information of the proximity warning sensor 12, and the like to the server 100. Then, the server 100 may determine the speed of the traveling vehicle VEH_d based on the information provided by the relay vehicle VEH_r.

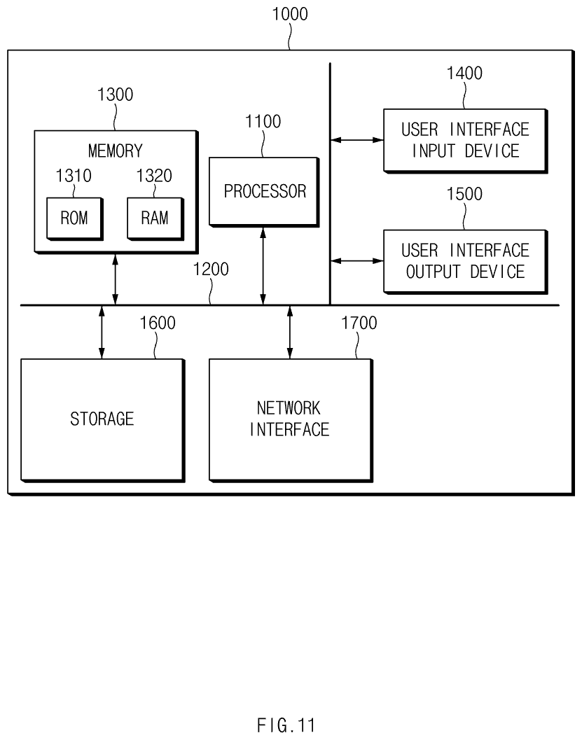

FIG. 11 illustrates a computing system according to an embodiment of the present disclosure.

Referring to FIG. 11, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the instructions (e.g., of an algorithm) described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

According to the embodiments of the present disclosure, it is possible to obtain location information and speed information of other vehicles in addition to a relay vehicle equipped with a GPS device and a communication device, thereby making it possible to generate traffic information based on a larger amount of data.

In addition, according to the embodiments of the present disclosure, it is possible to obtain location information and speed information of vehicles actually traveling on a road by determining the locations and speeds of other vehicles based on images acquired by vehicles traveling on a road.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for generating traffic information, the apparatus comprising:
a memory configured to store instructions for generating traffic information for determining a traffic volume on a road;
a processor configured to execute the instructions, wherein upon execution of the instructions, the processor is configured to:
determine a traveling vehicle by excluding duplicate vehicles from surrounding vehicles based on location information of relay vehicles traveling on the road and vehicle information of the surrounding vehicles, the surrounding vehicles being detected by the relay vehicles, and
generate the traffic information based on traveling information of the traveling vehicle.

2. The apparatus of claim 1, wherein the processor is configured to:
identify license plate information from the vehicle information of the surrounding vehicles; and
determine, as the traveling vehicle, one of the surrounding vehicles of which the license plate information are identical.

3. The apparatus of claim 2, wherein the processor is configured to decrypt the license plate information provided as encrypted data.

4. The apparatus of claim 1, wherein the processor is configured to:
identify relative locations of the surrounding vehicles with respect to the relay vehicle from the vehicle information of the surrounding vehicles;
determine absolute locations of the surrounding vehicles based on the location information of the relay vehicle and the relative locations of the surrounding vehicles; and
determine one of the surrounding vehicles as the traveling vehicle among the surrounding vehicles of which the absolute locations are identical.

5. The apparatus of claim 4, wherein the processor is configured to determine the absolute locations of the surrounding vehicles based on line information of the surrounding vehicles.

6. The apparatus of claim 4, wherein the processor is configured to determine duplicate vehicles among the surrounding vehicles based on color information or size information of the vehicle information of the surrounding vehicles.

7. The apparatus of claim 4, wherein the processor is configured to:
determine a speed of the traveling vehicle based on speed information of the relay vehicle and an amount of change in the relative location of the traveling vehicle over time; and
include the speed information of the traveling vehicle in the traffic information.

8. The apparatus of claim 7, wherein the processor is configured to:
determine the relative location of the traveling vehicle at predetermined time periods;
determine a relative speed of the traveling vehicle based on the amount of change in the relative location of the traveling vehicle at the predetermined time periods; and
determine a speed of the traveling vehicle based on the speed information of the relay vehicle and the relative speed of the traveling vehicle.

9. The apparatus of claim 7, wherein the processor is configured to:
determine a detection time at which the traveling vehicle is detected by a side-rear detection sensor of the relay vehicle;
determine a relative speed of the traveling vehicle based on a detection distance of the side-rear sensor and the detection time; and
determine a speed of the traveling vehicle based on the speed information of the relay vehicle and the relative speed of the traveling vehicle.

10. A server comprising the apparatus of claim 1, the server being operably connected to at least a vehicle.

11. A method for generating traffic information, the method comprising:
receiving, by a server, location information of relay vehicles on a road and vehicle information of surrounding vehicles detected by the relay vehicles;
determining, by the server, a traveling vehicle by excluding duplicate vehicles from surrounding vehicles based on the location information of the relay vehicles and the vehicle information of the surrounding vehicles; and
generating, by the server, the traffic information for determining a traffic volume on the road based on traveling information of the traveling vehicle.

12. The method of claim 11, wherein determining the traveling vehicle includes:
identifying license plate information from the vehicle information of the surrounding vehicles; and
determining, as the traveling vehicle, one of the surrounding vehicles of which the license plate information are identical.

13. The method of claim 12, wherein identifying the license plate information from the vehicle information includes:
receiving the license plate information recognized by the relay vehicle, which is encrypted data; and
decrypting the encrypted data.

14. The method of claim 11, wherein determining the traveling vehicle includes:
identifying relative locations of the surrounding vehicles with respect to the relay vehicle from the vehicle information of the surrounding vehicles;
determining absolute locations of the surrounding vehicles based on the location information of the relay vehicle and the relative locations of the surrounding vehicles; and
determining one of the surrounding vehicles as the traveling vehicle among the surrounding vehicles of which the absolute locations are identical.

15. The method of claim 14, wherein identifying relative locations of the surrounding vehicles includes identifying line information of the surrounding vehicles.

16. The method of claim 14, wherein determining the traveling vehicle further includes using color information or size information of the vehicle information of the surrounding vehicles.

17. The method of claim 14, wherein generating the traffic information based on the traveling information of the traveling vehicle further includes determining a speed of the traveling vehicle based on speed information of the relay vehicle and an amount of change in the relative location of the traveling vehicle over time.

18. The method of claim 17, wherein determining the speed of the traveling vehicle includes:
determining the relative location of the traveling vehicle at predetermined time periods;
determining a relative speed of the traveling vehicle based on the amount of change in the relative location of the traveling vehicle at the predetermined time periods; and
determining a speed of the traveling vehicle based on the speed information of the relay vehicle and the relative speed of the traveling vehicle.

19. The method of claim 17, wherein determining the speed of the traveling vehicle includes:
determining a detection time at which the traveling vehicle is detected by a side-rear detection sensor of the relay vehicle;
determining a relative speed of the traveling vehicle based on a detection distance of the side-rear sensor and the detection time; and
determining a speed of the traveling vehicle based on the speed information of the relay vehicle and the relative speed of the traveling vehicle.

20. The method of claim 11, wherein generating the traffic information includes matching a location and speed of the traveling vehicle to a link connecting nodes corresponding to points where a speed change occurs.
